(19) United States
(12) Patent Application Publication
(10) Pub. No.: US 2013/0335532 A1
(43) Pub. Date: Dec. 19, 2013

(54) IMAGE PROCESSING APPARATUS, IMAGE PROCESSING METHOD, AND PROGRAM

(71) Applicants: Kenji Tanaka, Kanagawa (JP); Yoshihiro Takahashi, Kanagawa (JP); Kazumasa Tanaka, Kanagawa (JP)

(72) Inventors: Kenji Tanaka, Kanagawa (JP); Yoshihiro Takahashi, Kanagawa (JP); Kazumasa Tanaka, Kanagawa (JP)

(73) Assignee: Sony Corporation, Tokyo (JP)

(21) Appl. No.: 14/002,829

(22) PCT Filed: Mar. 2, 2012
(86) PCT No.: PCT/JP2012/001427

§ 371 Date: Sep. 3, 2013

(30) Foreign Application Priority Data
Mar. 11, 2011 (JP) 2011-053844

(51) Int. Cl. G06T 7/00

(52) U.S. Cl. CPC G06T 7/0022
USPC 348/47

(57) ABSTRACT

The present disclosure is directed to an apparatus and a method for generating an image. A plurality of image capturing devices capture images including objects reflected by a curved mirror from predetermined angles. Image units included in a captured image are analyzed; and a distance for an object included in the captured images is determined according to the analyzing result.

### TECHNICAL FIELD

The present invention relates to image processing apparatuses, image processing methods, and programs, and particularly relates to an image processing apparatus, an image processing method, and a program which enable recognition of distances from a view point to objects in a whole sky with a simple configuration.

### BACKGROUND ART

In recent years, so-called 3D television sets have been broadly used, accuracy of car navigation systems has been enhanced, and robots have been put into practical use, and therefore, there is an increased demand for recognition of a position (distance from a camera) of a subject included in an image.

For example, a distance between a subject included in an image and a camera is obtained so that a so-called depth map is generated.

However, most map information used in general car navigation systems is generated by adding information on distances obtained by a laser distance meter to images captured by cameras. Therefore, a technique of recognizing a distance to a subject without using sensors other than cameras has been expected.

For example, by capturing images of the same subject from different positions using cameras, a distance to the subject from the cameras may be recognized. Note that capturing of images of the same subject from a plurality of camera positions is also referred to as “stereo imaging”.

Furthermore, when a 3D image is to be actually generated, distances of objects included in an image from a camera should be recognized. Specifically, in addition to a certain subject, distances of objects surrounding the certain subject should be recognized.

For example, a configuration in which two hyperboloidal mirrors disposed in upper and lower portions cause a vertical parallax difference so that stereo imaging of an entire surrounding area is performed has been proposed (refer to Non-Patent Document 1, for example).

Furthermore, a configuration in which images of a single circular cone mirror are captured from two different distances so that a vertical parallax difference occurs whereby stereo imaging of an entire surrounding area is performed has been proposed (refer to Non-Patent Document 2, for example).

Moreover, stereo imaging of an entire surrounding area using a rotation optical system has been proposed (refer to Non-Patent Document 3, for example).

According to these techniques, although distances to a target subject and objects surrounding the target subject from cameras may be roughly obtained, the hyperboloidal mirrors, the circular cone mirror, and the rotation optical system should be provided.

Meanwhile, stereo imaging using a spherical mirror which is comparatively easily obtained has been proposed (refer to Non-Patent Document 4, for example).

### CITATION LIST

### Non Patent Literature

[NPL 1]
Construction and Presentation of a Virtual Environment Using Panoramic Stereo Images of a Real Scene and Computer Graphics Models
[NPL 2]
Axial-Cones: Modeling Spherical Catadioptric Cameras for Wide-Angle Light Field Rendering
[NPL 3]
Omnistereo video imaging with rotating optics
[NPL 4]
Axial light field for curved mirrors

### SUMMARY OF INVENTION

### Technical Problem

However, According to the techniques disclosed in Non-Patent Documents 1 to 3, the hyperboloidal mirrors, the circular cone mirror, and the rotation optical system should be provided as described above. The hyperboloidal mirrors, the circular cone mirror, and the rotation optical system are not distributed as standard products or common products, and therefore, it is difficult to obtain the hyperboloidal mirrors, the circular cone mirror, and the rotation optical system with ease.

In addition, it is difficult to employ the configuration disclosed in Non-Patent Document 1 in which the hyperboloidal mirrors are disposed in the upper and lower portions in dairy living spaces in a factual manner, for example. In addition, according to Non-Patent Document 3, since a circular polarizing film is used as an optical system, image equality is restricted.

Furthermore, when any one of the techniques disclosed in Non-Patent Documents 1 to 4 is used, an image including a surrounding area (which is referred to as a “whole sky”) in vertical and horizontal directions and a front-back direction is not obtained by stereo imaging.

The present invention has been made in view of this circumstance to obtain distances to objects in a whole sky from a certain view point with a simple configuration.

According to the present invention, distances to objects in a whole sky from a certain view point may be obtained with a simple configuration.

According to an embodiment, an apparatus for generating an image comprises a plurality of image capturing devices that capture images including objects reflected by a curved mirror from predetermined angles. An analyzing unit analyzes image units included in a captured image; and a distance estimating unit determines the distance for an object included in the captured images according to the analyzing result of the analyzing unit.

According to another embodiment, the apparatus further comprises a depth image generating unit that generates a depth image according to the captured images.

According to yet another embodiment, the plurality of image capturing devices include two image capturing devices disposed at equal distances from the curved mirror.

According to yet another embodiment, the apparatus further comprises a mapping unit that maps the image units of captured images with virtual units on a plurality of predetermined curved virtual surfaces centered on the curved mirror and associates the virtual units and the image units of the captured images.

According to yet another embodiment, the curved mirror has a spherical shape, and the curved virtual surface has a cylindrical shape. The mapping unit determines a three-dimensional vector of a light beam reflected by a point of the curved mirror by using a coordinate of the point of the curved mirror and a coordinate of an image capturing device. The coordinates specify a three-dimensional space that has the center of the curved mirror as an origin, and the coordinate of the image capturing device represents a center of a lens of the image capturing device, and the mapping unit generates a mapped image by mapping an image unit corresponding to the point of the curved mirror with a virtual unit on a virtual curved surface according to the three-dimensional vector.

According to yet another embodiment, the distance estimating unit determines the distance for an object included in an image unit based on a minimum value of a location difference of the mapped virtual units associated with the image unit. The image unit includes a pixel or a region formed of a plurality of pixels. The mapping unit generates a plurality of mapped images by mapping a captured image to the plurality of the virtual curved surfaces having a series of radii, the distance estimating unit calculates absolute values of virtual units on the virtual curved surfaces, and the distance estimating unit estimates a distance to an object by using one radius that corresponds to the minimum difference absolute value among the calculated absolute values.

The present invention also contemplates the method performed by the apparatus described above.

To the accomplishment of the foregoing and related ends, certain illustrative embodiments of the invention are described herein in connection with the following description and the annexed drawings. These embodiments are indicative, however, of but a few of the various ways in which the principles of the invention may be employed and the present invention is intended to include all such aspects and their equivalents. Other advantages, embodiments and novel features of the invention may become apparent from the following description of the invention when considered in conjunction with the drawings. The following description, given by way of example, but not intended to limit the invention solely to the specific embodiments described, may best be understood in conjunction with the accompanying drawings, in which:

### BRIEF DESCRIPTION OF DRAWINGS

FIG. 1 is a diagram illustrating a case where a spherical mirror is captured by a camera.

FIG. 2 is a diagram illustrating a spherical mirror viewed by a person shown in FIG. 1.

FIG. 3 includes diagrams illustrating images of the spherical mirror captured by the person in various positions denoted by arrow marks shown in FIG. 1.

FIG. 4 is a diagram illustrating an image of the spherical mirror captured by a camera.

FIG. 5 is a diagram illustrating a space including the spherical mirror captured as shown in FIG. 4 and the camera as a three dimensional space.

FIG. 6 is a perspective view of FIG. 5.

FIG. 7 is a diagram illustrating a method for specifying a position of an object in the spherical mirror.

FIG. 8 is a block diagram illustrating a configuration of an image processing apparatus according to an embodiment to which the present technique is applied.

FIG. 9 is a flowchart illustrating a depth map generation process.

FIG. 10 is a flowchart illustrating an image mapping process.

FIG. 11 is a flowchart illustrating an image analysis process.

FIG. 12 is a flowchart illustrating a distance estimation process.

FIG. 13 includes diagrams further illustrating the depth map generation process.

FIG. 14 is a diagram still further illustrating the depth map generation process.

FIG. 15 is a diagram illustrating effective field angles obtained when the spherical mirror is captured using two cameras.

FIG. 16 is a diagram illustrating effective field angles obtained when the spherical mirror is captured using three cameras.

FIG. 17 is a block diagram illustrating a configuration of a personal computer.

### DESCRIPTION OF EMBODIMENTS

Hereinafter, an embodiment of the present invention will be described with reference to the accompanying drawings. It is noted that in this disclosure and particularly in the claims and/or paragraphs, terms such as “comprises,” “comprised,” “comprising,” and the like can have the meaning attributed to it in U.S. patent law; that is, they can mean “includes,” “included,” “including,” “including, but not limited to” and the like, and allow for elements not explicitly recited. Terms such as “consisting essentially of” and “consists essentially of” have the meaning ascribed to them in U.S. patent law; that is, they allow for elements not explicitly recited, but exclude elements that are found in the prior art or that affect a basic or novel characteristic of the invention. Embodiments of the present invention are disclosed or are apparent from and encompassed by, the following description.

First, features of a spherical mirror will be described.

A light beam reflected by a hyperboloidal mirror, for example, is converged to a point. However, a light beam reflected by a spherical mirror is not converged to a point.

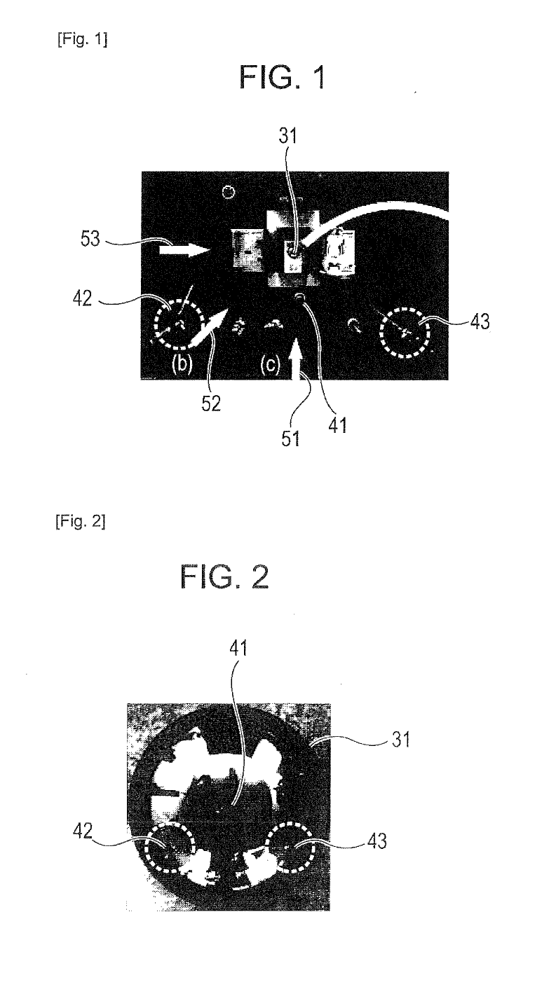

It is assumed that, as shown in FIG. 1, a person 41 and cameras 42 and 43 are in a spherical mirror 31. Note that the cameras 42 and 43 are located with a certain interval therebetween.

The person 41 sees the spherical mirror 31 as shown in FIG. 2. FIG. 2 is a diagram illustrating an image obtained when the person 41 captures an image of the spherical mirror 31 using a compact digital still camera. The image of the spherical mirror 31 is located in the center of FIG. 2, an image of the person 41 is located in the center of the image of the spherical mirror 31, and images of the cameras 42 and 43 are located on left and right portions in the image of the spherical mirror 31, respectively.

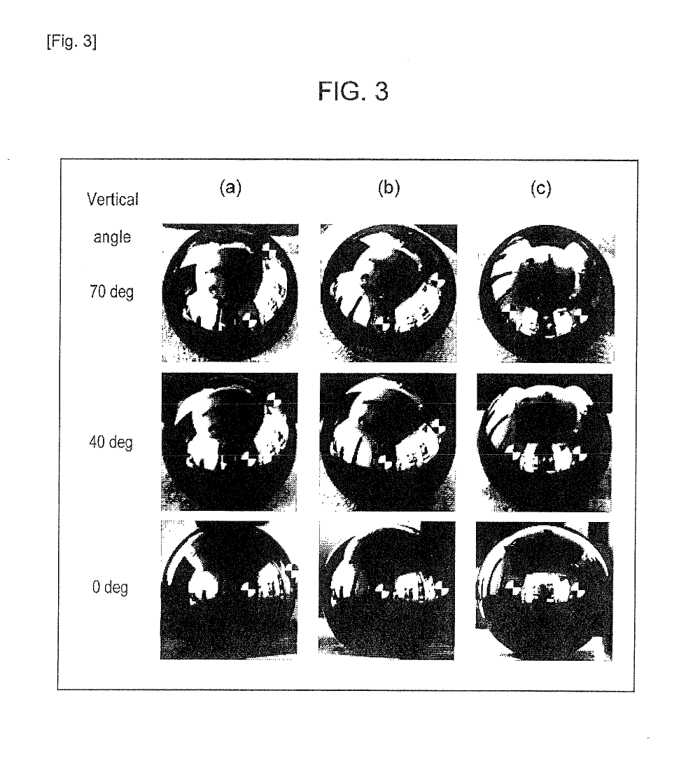

Here, a case where the person 41 moves and an image on a surface of the spherical mirror changes in accordance with the movement will be considered. FIG. 3 includes diagrams illustrating images obtained when the person captures images of the spherical mirror 31 from positions represented by arrow marks 51 to 53 shown in FIG. 1 using a compact digital still camera. Furthermore, in the examples of the images shown in FIG. 3, the images of the spherical mirror 31 are captured by the compact digital still camera while a vertical angle is changed.

Assuming that a direction of a sheet of FIG. 1 represents a horizontal direction, a depth direction of the sheet of FIG. 1 represents a vertical direction. Here, an angle obtained when a position in which a line which connects the center of the spherical mirror 31 and the center of a lens of the compact digital still camera to each other (an optical axis of the compact digital still camera) is parallel to the ground is determined as 0 degree is referred to as a “vertical angle”.

FIG. 3 includes the images of the spherical mirror 31 captured by the person using the compact digital still camera in the positions represented by the arrow marks 51 to 53 shown in FIG. 1 while a vertical angle is changed among 0 degree, 40 degrees, and 70 degrees. Specifically, FIG. 3 includes nine images obtained by changing a position of the compact digital still camera in three positions in the horizontal direction (represented by the arrow marks 51, 52, 53) and three positions in the vertical direction (vertical angles of 0 degree, 40 degrees, and 70 degrees).

Images of the cameras 42 and 43 are normally included in each of the nine images shown in FIG. 3 in respective two positions on the surface of the spherical mirror 31. Specifically, the images of the cameras 42 and 43 in the spherical mirror 31 are not overlapped with each other even when the image capturing is performed in any position.

This means that images having a parallax difference are normally captured when images of a subject are captured using two cameras through a spherical mirror.

Next, the relationship between an image in the spherical mirror and a position of an object in the real world will be described.

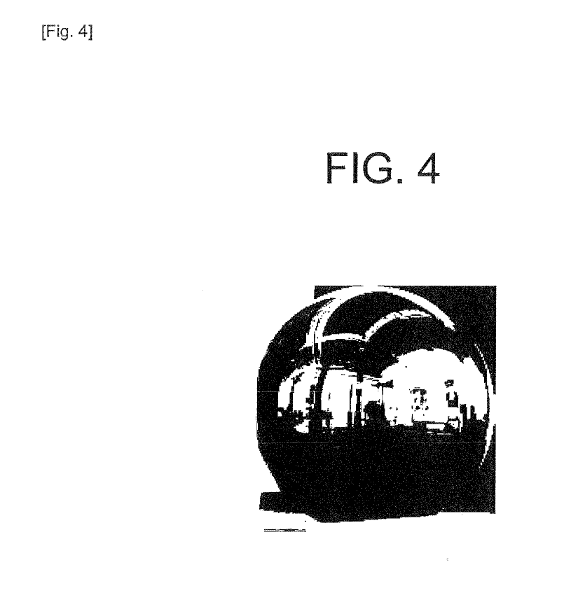

A case where an image of a spherical mirror is captured from a certain position as shown in FIG. 4 will be considered, for example. FIG. 4 is a diagram illustrating an image of a spherical mirror captured using a camera positioned away from the center of the spherical mirror by a certain distance. Images of objects located near the spherical mirror are included in the captured image of the spherical mirror.

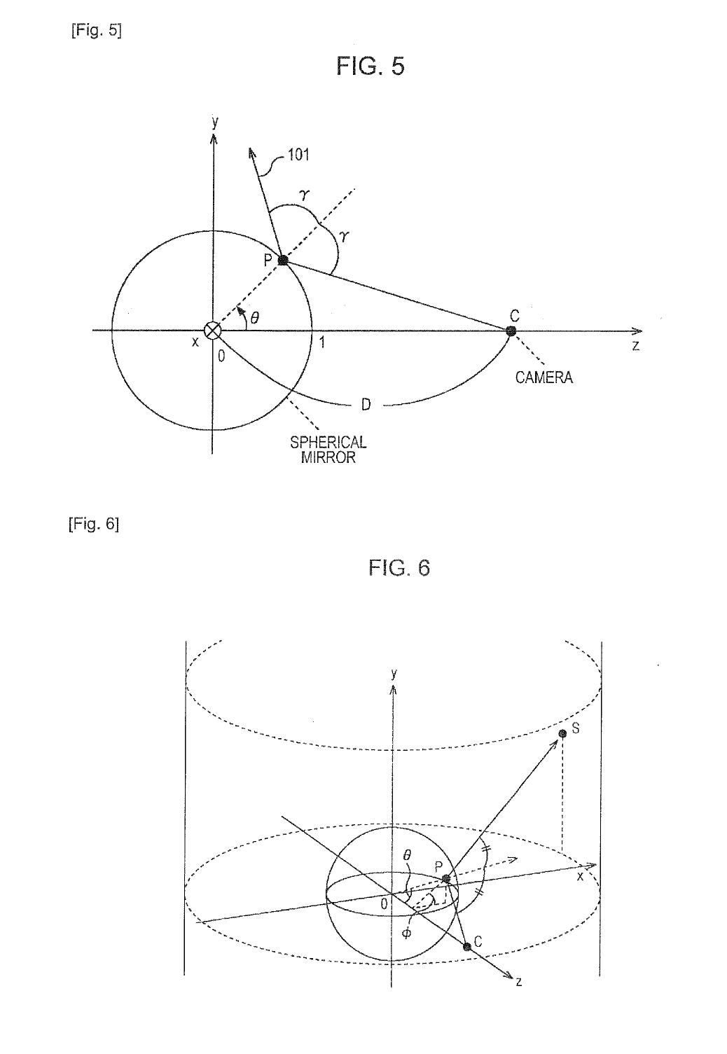

Here, the image of a space including the spherical mirror captured as shown in FIG. 4 and the camera is represented as a three dimensional space of (x, y, z) as shown in FIG. 5. In this case, a z axis represents a horizontal direction of FIG. 5, a y axis represents a vertical direction of FIG. 5, and an x axis represents a depth direction of FIG. 5 (a direction orthogonal to a sheet). In FIG. 5, a camera is installed in a position away from the center of a sphere on the z axis by a distance D and an image of the spherical mirror is captured using the camera.

As shown in FIG. 5, when the x axis is defined as the direction which is vertical to the sheet, a contour line of the spherical mirror may be represented by a circle in a (z, y) plane. Furthermore, the position of the camera may be represented by a coordinate (D, 0) on the (z, y) plane.

It is assumed that a point on the circle representing the contour line of the spherical mirror shown in FIG. 5 is represented by a polar coordinate (r, phi). Here, “phi” means an angle defined by a line which connects the point on the circle of the contour line of the spherical mirror and a center point of the spherical mirror and the (x, y) plane. Note that, a radius of the circle is 1, a position corresponding to three o'clock represents “phi=0 degree”, and a position corresponding to twelve o'clock represents “phi=90 degrees”. For example, a single point P on the circle of the contour line of the spherical mirror shown in FIG. 5 has a phi component of 90 degrees, and an angle defined by a line which connects the point P and the center point of the spherical mirror to each other and the (z, y) plane is theta.

In this case, the circle of the contour line of the spherical mirror is represented by Expression (1).

X²+Y²=1 (1)

A straight line which connects a certain point on the circle representing the contour of the spherical mirror and the position of the camera to each other contacts the circle representing the contour of the spherical mirror when an estimated image height (that is, an r component in the polar coordinate (r, phi)) is 1. Therefore, a straight line PC which connects a certain point P on the circle representing the contour of the spherical mirror and a point C representing the position of the camera shown in FIG. 5 is represented by Expression (2).

$$\begin{matrix}Expression ( 2 ) & \\ y = - \frac{r}{{D}^{2} - 1} ( z - D ) & ( 2 )\end{matrix}$$

A coordinate (y, z) of the point P may be calculated by Expression (3) using Expressions (1) and (2).

$$\begin{matrix}Expression ( 3 ) & \\ [ \begin{matrix}y \\ z\end{matrix} ] = \frac{r}{{D}^{2} + {r}^{2} - 1} [ \begin{matrix}r \sqrt{{D}^{2} - 1} ( D - \sqrt{1 - {r}^{2}} ) \\ {Dr}^{2} + ( {D}^{2} - 1 ) \sqrt{1 - {r}^{2}}\end{matrix} ] & ( 3 )\end{matrix}$$

Furthermore, a light beam is reflected in a certain point on the surface of the spherical mirror with an angle the same as an angle of a normal line relative to the spherical surface. Specifically, a direction of a light beam which is incident on the lens of the camera from a certain point of the surface of the spherical mirror is automatically determined if an angle of a straight line which connects the lens of the camera and the certain point on the surface of the spherical mirror relative to the normal line is obtained. Specifically, if an angle γ defined by the straight line CP shown in FIG. 5 and a normal line denoted by a dotted line in FIG. 5 is obtained, a direction of an object located in the point P on the surface of the spherical mirror may be specified. Therefore, the object located in the point P on the surface of the spherical mirror faces a direction represented by an arrow mark 101 shown in FIG. 5.

FIG. 6 is a perspective view of FIG. 5. Specifically, although the x axis represents the direction orthogonal to the sheet and is denoted by a point in FIG. 5, the x axis is not orthogonal to a sheet and is denoted by a straight line in FIG. 6. Note that, although the phi component in the point P is 90 degrees for convenience sake in FIG. 5, a phi component in a point P is set as an angle larger than 0 degree and smaller than 90 degrees in FIG. 6.

Furthermore, it is assumed that, in FIG. 6, an object an image of which is captured by a light beam which is incident on the lens of the camera after being reflected by the point P is located in a point S.

Here, since θ may be obtained using an arc cos z, the point P on the surface of the spherical mirror may be represented by Expression (4) as a polar coordinate of the

P=(cos φ sin θ, sin φ sin θ, cos θ) (4)

Furthermore, as described above, a light beam is reflected at a point on the surface of the spherical mirror with an angle the same as an angle defined by the spherical surface and the normal line at the point. Specifically, an angle defined by a line which connects the point C representing the position of (the lens of) the camera and the point P to each other and the normal line of the spherical surface is normally equal to an angle defined by a line which connects the point S representing the position of the object and the point P to each other and the normal line of the spherical surface. In this case, a vector obtained by adding a vector of a unit length obtained by the straight line PC and a vector of a unit length obtained by the straight line PS to each other is normally parallel to a straight line OP which connects the center point O of the sphere and the point P to each other. That is, Expression (5) is satisfied.

$$\begin{matrix}Expression ( 5 ) & \\ \frac{\vec{PC}}{\vert \vec{PC} \vert} + \frac{\vec{PS}}{\vert \vec{PS} \vert} \vert \vert \vec{OP} & ( 5 )\end{matrix}$$

Note that a symbol “∥” included in Expression (5) represents parallelism.

Using Expressions (4) and (5), a vector in a direction in which a light beam is reflected at the point P when viewed from the camera (that is, a vector representing a direction of a light beam which is incident on the point P) may be obtained by Expression (6).

$$\begin{matrix}Expression ( 6 ) & \\ [ \begin{matrix}{m}_{x} \\ \begin{matrix}{m}_{y} \\ {m}_{z}\end{matrix}\end{matrix} ] = \frac{1}{\sqrt{1 + {D}^{2} - 2 D cos θ}} [ \begin{matrix}cos φ ( - 1 + 2 D cos θ ) sin θ \\ sin φ ( - 1 + 2 D cos θ ) sin θ \\ - cos θ + D cos 2 θ\end{matrix} ] & ( 6 )\end{matrix}$$

In this way, a direction of the object in the real world included in the image of the spherical mirror captured as shown in FIG. 4 may be specified on the assumption that a distance between the lens of the camera and the center of the spherical mirror has been obtained.

A method for capturing an image of a spherical mirror using a single camera and specifying a direction of an object in the spherical mirror in the real world has been described hereinabove. However, when the spherical mirror is captured using two cameras, a position of the object in the spherical mirror in the real world may be specified.

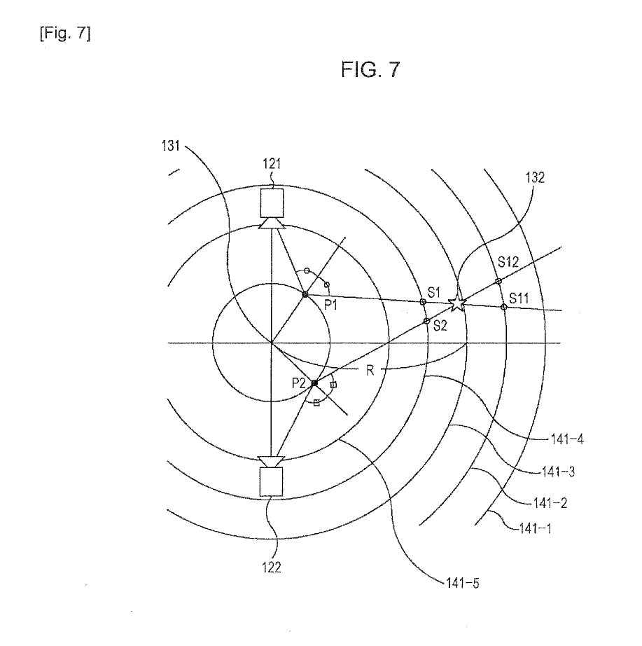

For example, as shown in FIG. 7, images of a spherical mirror 131 are captured using cameras 121 and 122 from different directions. In this example, the cameras 121 and 122 are located in positions having the same distance from a center point of the spherical mirror 131 so as to be symmetrical relative to a horizontal straight line in FIG. 7.

It is assumed that an object 132 is located in a position corresponding to a point P1 in the image of the spherical mirror captured by the camera 121. Furthermore, is assumed that the object 132 is located in a position corresponding to a point P2 in the image of the spherical mirror captured by the camera 121.

As described above, when an image of a spherical mirror is captured using a single camera, a direction of an object in the spherical mirror in the real world is specified. Accordingly, vectors representing directions of the object 132 from the points P1 and P2 may be specified. Thereafter, a point corresponding to an intersection of straight lines obtained by extending the specified vectors is obtained so that a position of the object 132 in the real world is specified.

In this technique, images of a spherical mirror are captured using a plurality of cameras so that a position of an object in the captured image of the spherical mirror is specified.

Note that it is difficult to specify positions of the object 132 in distorted images in the spherical mirror captured by the cameras 121 and 122 by analyzing the distorted images in practice.

Therefore, in this technique, an image in the spherical mirror is mapped in a cylinder screen having an axis corresponding to a position of the center of the spherical mirror and the image is analyzed. For example, as shown in FIG. 6, the spherical mirror is surrounded by a cylinder and an image in the spherical mirror is mapped in an inner surface of the cylinder. Note that the cylinder is represented by two straight lines extending in the vertical direction in FIG. 6 and the axis serving as the center of the cylinder corresponds to the y axis. Note that the cylinder is represented as a see-through cylinder for convenience sake.

As described above, since the point C representing the position of the camera shown in FIG. 6 has been obtained, a pixel corresponding to the point P on the surface of the spherical mirror in the image captured by the camera may be mapped in a point S on the inner surface of the cylinder. Specifically, pixels of the spherical mirror in the captured image are assigned to the inner surface of the cylinder in accordance with vectors obtained using Expression (6). By this, an image of the object in the spherical mirror is displayed in the inner surface of the cylinder.

Then, the cylinder is cut to open by a vertical straight line in FIG. 6 so as to be developed as a rectangular (or square) screen. In this way, a rectangular (or square) image to which the pixels of the spherical mirror are mapped may be obtained. It is apparent that the cylinder is virtual existence and the image may be obtained by calculation in practice.

As described above, the two rectangular (or square) images are obtained from the images of the spherical mirror captured by the two cameras, for example, and difference absolute values of pixels in certain regions in the images are calculated. Then, it is estimated that an object displayed in a region corresponding to a portion in which a difference absolute value of the two images is 0 substantially has a distance from the center of the spherical mirror the same as a radius of the cylinder.

It is assumed that concentric circles 141-1 to 141-5 shown in FIG. 7 having the center point of the spherical mirror 131 as the centers serve as cylinder screens. Note that, in a case of FIG. 7, the cylinders have certain heights in a direction orthogonal to a sheet.

The images captured by the camera 121 and the image captured by the camera 122 are developed as rectangular images by cutting the cylinder to open after the pixels on the spherical mirror 131 are mapped in the cylinder corresponding to the concentric circle 141-3 having a radius R. In this case, the object 132 is located in the same position in the rectangular images captured by the cameras 121 and 122.

On the other hand, the image captured by the camera 121 and the image captured by the camera 122 are developed as rectangular images by cutting the cylinder to open after the pixels on the spherical mirror 131 are mapped in the cylinder corresponding to the concentric circle 141-4 having a radius smaller than the radius R. In this case, in the image captured by the camera 121, the object 132 is displayed in a position corresponding to a point S1 whereas in the image captured by the camera 122, the object 132 is displayed in a position corresponding to a point S2.

Furthermore, the image captured by the camera 121 and the image captured by the camera 122 are developed as rectangular images by cutting the cylinder to open after the pixels on the spherical mirror 131 are mapped in the cylinder corresponding to the concentric circle 141-2 having a radius larger than the radius R. In this case, in the image captured by the camera 121, the object 132 is displayed in a position corresponding to a point S11 whereas in the image captured by the camera 122, the object 132 is displayed in a position corresponding to a point S12.

As described above, the object 132 is located in the same position in the rectangular images captured by the cameras 121 and 122 only when the cylinder has the radius R. Accordingly, when the pixels of the spherical mirror 131 are mapped in the cylinder having the radius the same as the distance between the object 132 and the center of the spherical mirror 131, a difference absolute value of a pixel of the object 132 is 0.

Therefore, when the image captured by the camera 121 and the image captured by the camera 122 are mapped in the different cylinders having different radii and a difference absolute value of the two images is obtained, the position of the object in the captured spherical mirror may be specified. In other words, a distance of the position of the object in the captured image of the spherical mirror from the center of the spherical mirror may be specified using the difference absolute value and values of the radii of the cylinders.

Furthermore, in the present technique, the image of the spherical mirror is captured before the image of the object (subject) in the captured image of the spherical mirror is analyzed. Since objects located in the vertical direction and the horizontal direction are included in the image of the spherical mirror, an image of a subject located in the vertical direction or the lateral direction may be captured using a normal camera. For example, when the cameras 121 and 122 are installed as shown in FIG. 7, a surrounding image including regions in the vertical direction, the horizontal direction, and a front-back direction (which is referred to as a “whole sky image”) may be captured.

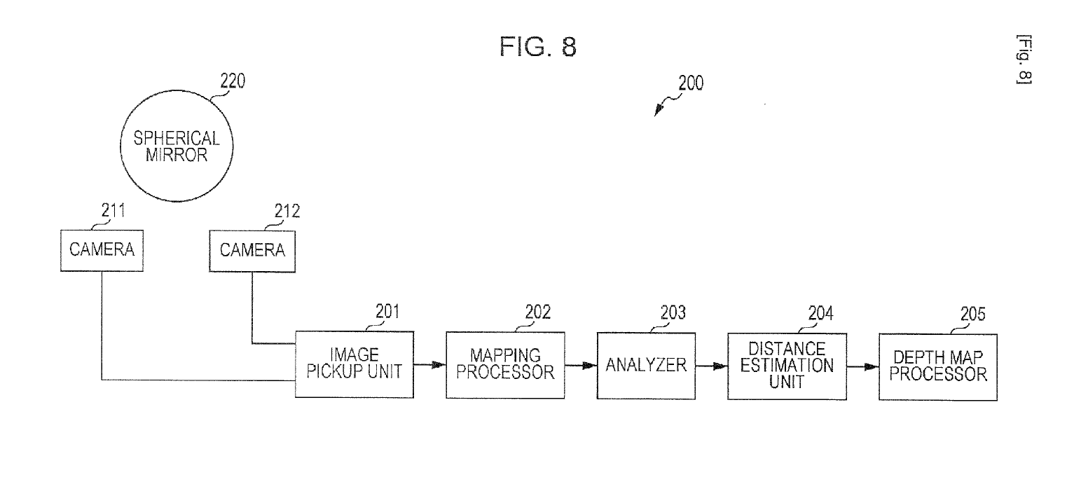

FIG. 8 is a block diagram illustrating a configuration of an image processing apparatus according to an embodiment to which the present technique is applied. An image processing apparatus 200 performs stereo imaging using a spherical mirror so as to obtain a whole sky image and generates a depth map of a subject included in the image. Note that the depth map is data obtained by associating a pixel of the subject with a distance from a camera (or the center of the spherical mirror).

As shown in FIG. 8, the image processing apparatus 200 includes an image pickup unit 201, a mapping processor 202, an analyzer 203, a distance estimation unit 204, and a depth map processor 205.

The image pickup unit 201 controls cameras 211 and 212 connected thereto so that the cameras 211 and 212 capture images of a spherical mirror 220 from different directions. According to an embodiment, the cameras 211 and 212 are placed at equal distances from the spherical mirror. According to another embodiment, the image processing apparatus may use other curved mirrors, such as a cylindrical mirror. The image pickup unit 201 supplies data of the image captured by the camera 211 and data of the image captured by the camera 212 to the mapping processor 202.

The mapping processor 202 performs a process of extracting an image of the spherical mirror 220 from the data of the image captured by the camera 211 and mapping the image of the spherical mirror 220 in a virtual cylinder. According to an embodiment, virtual surfaces of other shapes may be used, such as a spherical virtual surface. Furthermore, the mapping processor 202 similarly performs a process of extracting an image of the spherical mirror 220 from the data of the image captured by the camera 212 and mapping the image of the spherical mirror 220 in a virtual cylinder. For example, the mapping is performed such that, as described with reference to FIGS. 6 and 7, pixels of the spherical mirror in the captured image are assigned to inner surfaces of the cylinders in accordance with vectors obtained using Expression (6).

Note that, information on arrangement of the spherical mirror 220 and the cameras 211 and 212 is registered in advance in the image processing apparatus 200. Specifically, in the image processing apparatus 200, since a radius of the spherical mirror 220 and coordinates of positions of the centers of the lenses of the cameras 211 and 212 in an (x, y, z) space setting the center of the spherical mirror 220 as an origin have been obtained, calculation of Expression (6) may be performed.

Furthermore, the mapping processor 202 changes a radius of the vertical cylinder in a step-by-step manner and maps the images of the spherical mirror 220 in cylinders having different radii. For example, the mapping is performed on a cylinder having a radius R1, a cylinder having a radius R2, . . . , and a cylinder having a radius Rn. Then, the mapping processor 202 associates the different radii with a pair of the mapped images captured by the cameras 211 and 212 and supplies the pair to the analyzer 203.

The analyzer 203 calculates difference absolute values of pixels of the pair of the images which are captured by the cameras 211 and 212 and which are mapped by the mapping processor 202. The analyzer 203 calculates the difference absolute values of the pixels for each radius of the cylinders (for example, the radius R1, R2, . . . , or Rn) as described above.

Then, the analyzer 203 supplies data obtained by associating the radii, positions of the pixels (coordinates of the pixels, for example), and the difference absolutes with one another to the distance estimation unit 204.

The distance estimation unit 204 searches for the minimum value among the difference absolute values of the pixel positions in accordance with the data supplied from the analyzer 203. Then, a radius corresponding to the minimum value among the difference absolute values is specifies and the radius is stored as a distance between the subject including the pixel and the center of the spherical mirror 220. In this way, distances of the pixels included in the image in the spherical mirror 220 from the center of the spherical mirror 220 are stored.

The depth map processor 205 generates a depth map using data obtained as a result of the process performed by the distance estimation unit 204.

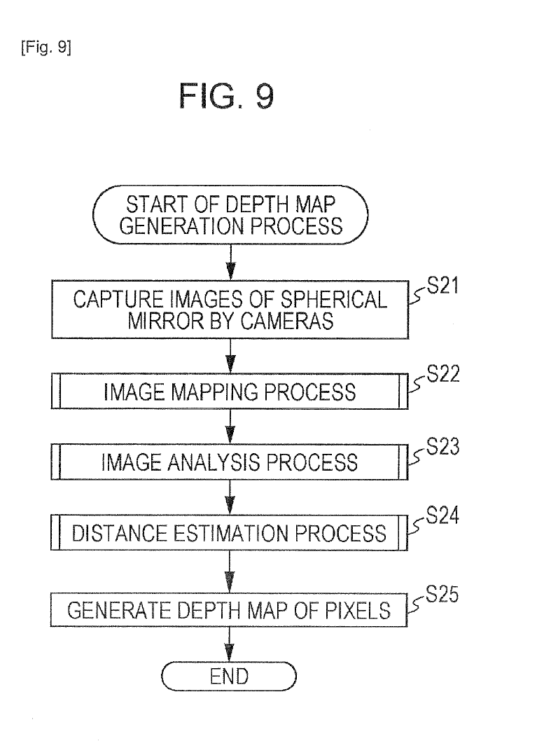

Next, an example of a depth map generation process performed by the image processing apparatus 200 shown in FIG. 8 will be described with reference to a flowchart shown in FIG. 9.

In step S21, the image pickup unit 201 captures images of the spherical mirror 220 using a plurality of cameras. The image pickup unit 201 controls the cameras 211 and 212 connected thereto so that the cameras 211 and 212 capture images of the spherical mirror 220, for example. The image pickup unit 201 supplies data of the image captured by the camera 211 and data of the image captured by the camera 212 to the mapping processor 202.

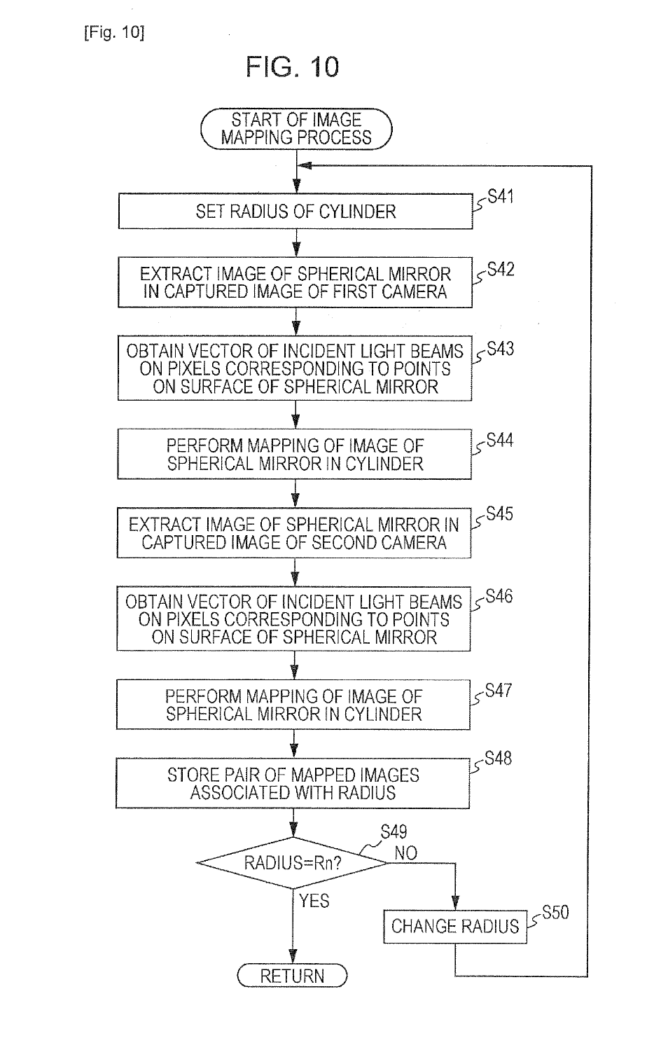

In step S22, the mapping processor 202 performs a mapping process which will be described hereinafter with reference to FIG. 10.

Here, an example of the mapping process performed in step S22 of FIG. 9 will be described in detail with reference to a flowchart shown in FIG. 10.

In step S41, the mapping processor 202 sets radii of cylinders which will be described hereinafter in step S44. As the radii of the cylinders, radii R1, R2, . . . , Rn are predetermined and the radii R1, R2, . . . , and Rn are successively set as a radius one by one. In step S41, first, the radius R1 is set, for example.

In step S42, the mapping processor 202 extracts an image of the spherical mirror 220 from data of an image captured in the process of step S21 shown in FIG. 9 by a first camera (the camera 211, for example).

In step S43, the mapping processor 202 obtains vectors of light beams which are incident on pixels corresponding to points on a surface of the spherical mirror. To express the light beam in an alternative way, the vectors are for the light beams that are reflected by the points on the surface of the spherical mirror. Here, for example, calculation of Expression (6) described above is performed so that the vectors are obtained.

In step S44, the mapping processor 202 virtually assigns the pixels of the image of the spherical mirror 220 extracted in the process of step S42 to an inner surface of the cylinder in accordance with the vectors obtained in the process of step S43 whereby mapping is performed. In this way, a rectangular (or square) image is generated by mapping the image of the spherical mirror 220 captured by the camera 211. The image generated in this way is referred to as a “first-camera mapping image”.

In step S45, the mapping processor 202 extracts an image of the spherical mirror 220 from data of an image captured in the process of step S21 shown in FIG. 9 by a second camera (the camera 212, for example).

In step S46, the mapping processor 202 obtains vectors of light beams which are incident on pixels corresponding to points on the surface of the spherical mirror. Here, for example, calculation of Expression (6) described above is performed so that the vectors are obtained.

In step S47, the mapping processor 202 virtually assigns the pixels of the images of the spherical mirror 220 extracted in the process of step S45 to the inner surface of the cylinder in accordance with the vectors obtained in the process of step S46 whereby mapping is performed. In this way, a rectangular (or square) image is generated by mapping the image of the spherical mirror 220 captured by the camera 212. The image generated in this way is referred to as a “second-camera mapping image”.

In step S48, the mapping processor 202 associates a pair of the first-camera mapping image generated in the process of step S44 and the second-camera mapping image generated in the process of step S47 with the radii set in the process of step S41 and stores the pair of images.

In step S49, the mapping processor 202 determines whether a radius Rn has been set as the radius of the cylinder. For example, in this case, since the radius R1 has been set, it is determined that the radius Rn has not been set in step S49 and the process proceeds to step S50.

In step S50, the radius is changed. For example, the radius is changed from the radius R1 to the radius R2. Subsequently, the process returns to step S41. Then, the processes described above are repeatedly performed for the cases of the radii R2, R3, . . . , and Rn.

When it is determined that the radius Rn has been set as the radius of the cylinder in step S49, the process is terminated.

In this way, the image mapping process is performed.

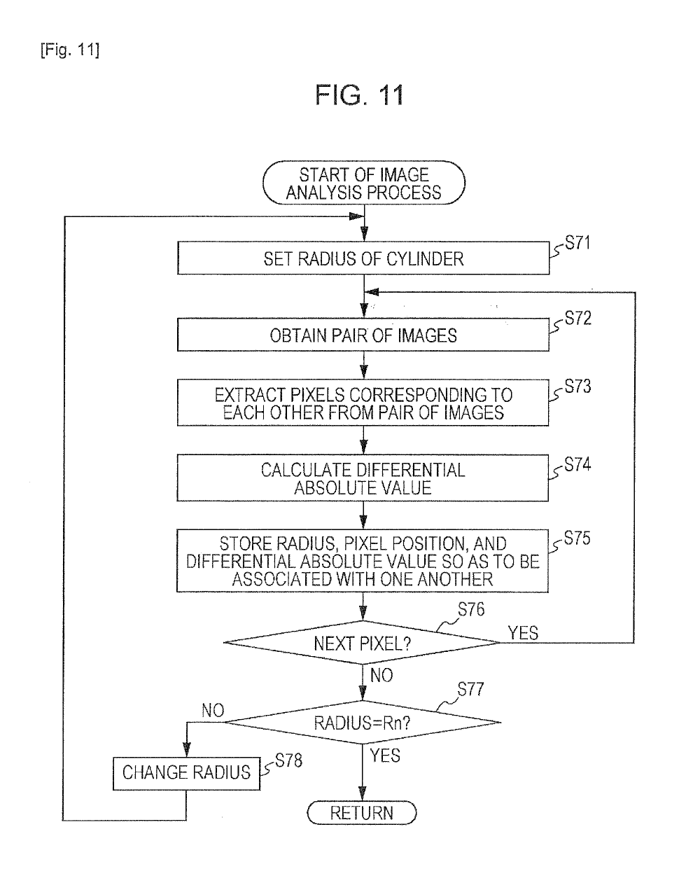

Referring back to FIG. 9, after the process in step S22, the process proceeds to step S23. In step S23, the analyzer 203 performs an image analysis process which will be described hereinafter with reference to FIG. 11.

Here, an example of the image analysis process performed in step S23 of FIG. 9 will be described in detail with reference to a flowchart shown in FIG. 11.

In step S71, the analyzer 203 sets a radius of a cylinder. For example, radii R1, R2, . . . , Rn are successively set as the radius one by one.

In step S72, the analyzer 203 obtains one of pairs of mapping images stored in the process of step S48. For example, when the radius R1 is set in step S71, one of the pairs of mapping images which is associated with the radius R1 is obtained.

In step S73, the analyzer 203 extracts pixels corresponding to each other from the pair of mapping images obtained in the process of step S72. For example, assuming that a pixel of a mapping image is represented by an (x, y,) coordinate, a pixel corresponding to a coordinate (0, 1) in the first-camera mapping image and a pixel corresponding to a coordinate (0, 1) in the second-camera mapping image are extracted as pixels corresponding to each other.

In step S74, the analyzer 203 calculates difference absolute values of the pixels extracted in the process of step S73.

In step S75, the analyzer 203 stores the radius set in step S71, positions (or coordinates) of the pixels extracted in step S73, and the difference absolutes obtained in step S74 after the radius, the positions, and the difference absolutes are associated with one another.

In step S76, it is determined whether the next pixel exists. When at least one of pixels at all coordinates in the mapping images has not been subjected to the calculation for obtaining a difference absolute value, it is determined that the next pixel exists in step S76.

In step S76, when it is determined that the next pixel is to be processed, the process returns to step S72 and the processes in step S72 onwards are performed again. For example, next, a difference absolute value of a pixel corresponding to a coordinate (0, 2) is obtained.

When it is determined that the next pixel does not exist in step S76, the process proceeds to step S77.

In step S77, the analysis processor 203 determines whether a radius Rn has been set as the radius of the cylinder. For example, in this case, since the radius R1 has been set, it is determined that the radius Rn has not been set in step S77 and the process proceeds to step S78.

In step S78, the radius is changed. For example, the radius is changed from the radius R1 to the radius R2. Then, the process returns to step S71. Then, the processes described above are repeatedly performed for the cases of the radii R2, R3, . . . , and Rn.

When it is determined that the radius Rn has been set as the radius of the cylinder in step S77, the process is terminated.

In this way, the image analysis process is performed.

Note that, although the example in which a difference absolute value is calculated for each pixel has been described hereinabove, a sum of difference absolute values may be calculated for each rectangular region including a predetermined number of pixels and the sum of difference absolute values may be stored after being associated with a coordinate of the center of the region and a radius.

Referring back to FIG. 9, after the process in step S23, the process proceeds to step S24.

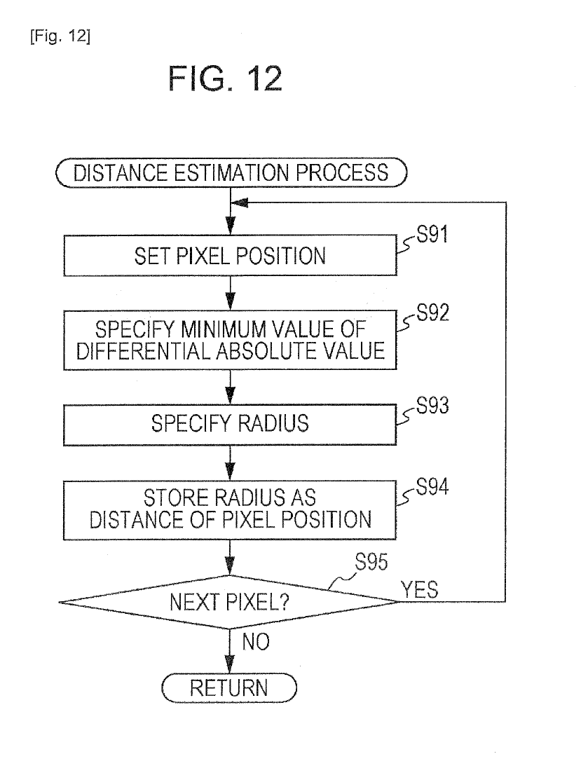

In step S24, the distance estimation unit 204 performs a distance estimation process which will be described hereinafter with reference to FIG. 12.

Here, an example of the distance estimation process performed in step S24 of FIG. 9 will be described in detail with reference to a flowchart shown in FIG. 12.

In step S91, the distance estimation unit 204 sets a pixel position. For example, pixels of the mapping images are represented by (x, y) coordinates and the individual coordinates are successively set one by one.

In step S92, the distance estimation unit 204 specifies the minimum value of one of the difference absolute values which are stored after being associated with the pixel position set in step S91. Here, the data stored in the process of step S75 is retrieved so that the minimum value of the difference absolute value in the pixel position is specified, for example.

In step S93, the distance estimation unit 204 specifies one of the radii which is stored after being associated with the difference absolute value specified in the process of step S92.

In step S94, the distance estimation unit 204 stores the radius specified in the process of step S93 as a distance of the pixel position. Specifically, a distance between a subject corresponding to the pixel in the pixel position and the center of the spherical mirror 220 in the real world is estimated.

In step S95, the distance estimation unit 204 determines whether the next pixel exists. When at least one of pixels at all coordinates has not been subjected to the distance estimation, it is determined that the next pixel exists in step S95.

In step S95, when it is determined that the next pixel exists, the process returns to step S91 and the processes in step S91 onwards are performed again.

When it is determined that the next pixel does not exist in step S95, the process is terminated.

In this way, the distance estimation process is performed.

Note that, although the example in which a distance is estimated for each pixel has been described hereinabove, a distance may be estimated for an image unit that includes a group of pixels, such as each rectangular region including a predetermined number of pixels. The rectangular region may center on a pre-selected pixel. The difference absolute value of an image unit may be the difference absolute value of the center or may be an accumulated difference absolute values of all the pixels included in the image unit.

Referring back to FIG. 9, after the process in step S24, the process proceeds to step S25.

In step S25, the depth map processor 205 generates a depth map using the data obtained as a result of the process in step S24.

In this way, the depth map generation process is performed.

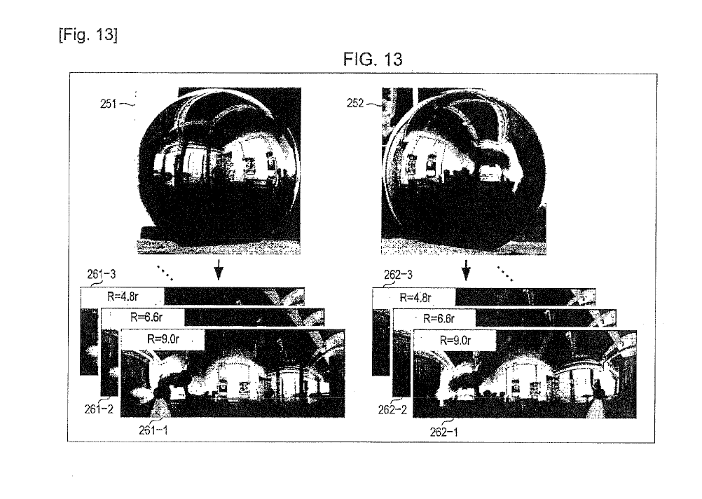

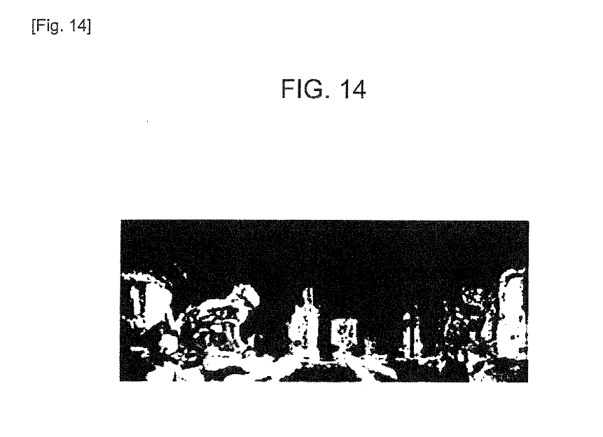

FIGS. 13 and 14 are diagrams further illustrating the depth map generation process.

Images 251 and 252 shown in FIG. 13 are examples of images captured in the process of step S21 shown in FIG. 9 and represent the image captured by the camera 211 (the image 251) and the image captured by the camera 212 (the image 252).

Images 261-1 to 261-3 shown in FIG. 13 are examples of first-camera mapping images generated in step S44 shown in FIG. 10. In these examples, the image 261-1 is a mapping image corresponding to the radius (R) of the cylinder of 9.0r. The image 261-2 is a mapping image corresponding to the radius (R) of the cylinder of 6.6r. The image 261-3 is a mapping image corresponding to the radius (R) of the cylinder of 4.8r.

Furthermore, images 262-1 to 262-3 shown in FIG. 13 are examples of second-camera mapping images generated in step

S47 shown in FIG. 10. In these examples, the image 262-1 is a mapping image corresponding to the radius (R) of the cylinder of 9.0r. The image 262-2 is a mapping image corresponding to the radius (R) of the cylinder of 6.6r. The image 262-3 is a mapping image corresponding to the radius (R) of the cylinder of 4.8r.

FIG. 14 is a diagram illustrating the depth map generated in the process of step S25 shown in FIG. 9. In this example, the depth map is generated as an image. In the image, as pixels corresponding to subjects are located near the center of the spherical mirror 220, the subjects are represented whiter whereas as pixels corresponding to subjects are located far from the center of the spherical mirror 220, the subjects are represented darker. By this, a sense of perspective of the subjects may be recognized at first sight.

The depth map shown in FIG. 14 is merely an example and the depth map may be generated in another method.

As described above, when the image processing apparatus according to the present technique is employed, a depth map may be generated by performing whole-sky stereo imaging using a spherical mirror.

For example, hyperboloidal mirrors, a circular cone mirror, and a rotation optical system which are difficult to obtain are not required and only a spherical mirror which is commercially used may be used. Furthermore, without employing a configuration in which a camera and hyperboloidal mirrors are vertically arranged which is difficult to be employed in a daily life space in practice, images including regions in a vertical direction, a horizontal direction, and a front-back direction may be subjected to stereo imaging. Accordingly, when the camera is appropriately installed, images in any direction in the whole sky may be obtained by the stereo imaging.

As described above, according to the present technique, distances of objects included in the whole sky from a certain view point (a spherical mirror, for example) may be obtained with a simple configuration.

Although the image processing apparatus 200 uses the two cameras to capture the images of the spherical mirror 220 in the foregoing embodiment, three or more cameras may be used.

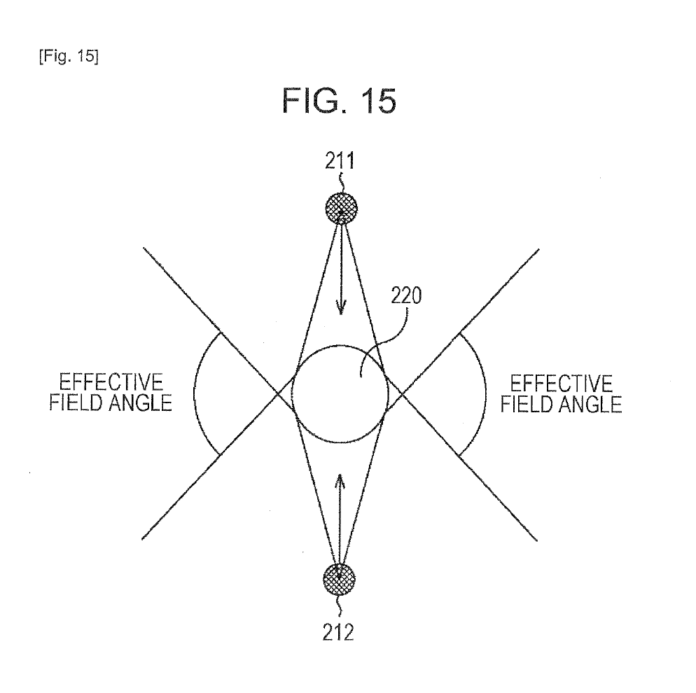

For example, as shown in FIG. 15, when the cameras 211 and 212 are installed in positions which are point symmetrical relative to a point corresponding to the center of the spherical mirror, whole-sky images may be captured. However, a range in which distances to subjects are appropriately estimated is limited. Specifically, when a distance to a subject is to be appropriately estimated, the same subject should be included in the image of the spherical mirror 220 captured by the camera 211 and the image of the spherical mirror 220 captured by the camera 212.

A distance to a subject which is only included in the image of the spherical mirror 220 captured by one of the cameras is not appropriately estimated. Therefore, the estimation of a distance to a subject is performed when the subject is located within ranges of effective field angles shown in FIG. 15. A distance of a subject located out of the ranges of the effective field angles (non-effective field angles) shown in FIG. 15 is not appropriately estimated. Note that, when the cameras 211 and 212 are located further from the spherical mirror 220, larger effective field angles may be obtained. However, non-effective field angles do not become 0.

Specifically, when the two cameras are used, whole-sky images are not simultaneously captured by stereo imaging.

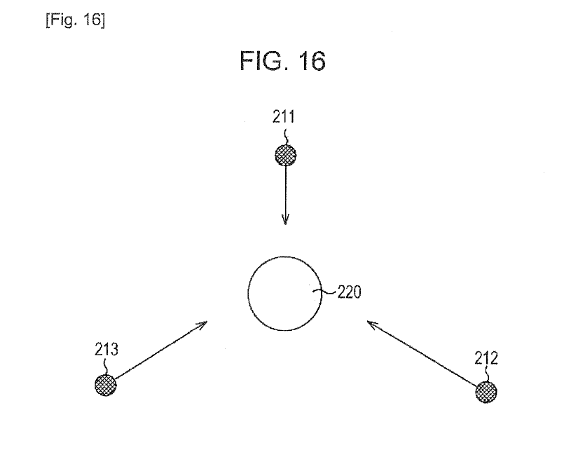

For example, when three cameras are installed as shown in FIG. 16, a non-effective field angle becomes 0. In the example shown in FIG. 16, for example, a camera 213 is additionally connected to the image pickup unit 201 shown in FIG. 8 and images of the spherical mirror 220 are captured using three cameras, i.e., the cameras 211 to 213. In this case, the cameras 211 to 213 are installed in vertices of a regular triangle having the point corresponding to the center of the spherical mirror as a center of gravity. By this, any subject in any position in a space shown in FIG. 16 may be included in the images of the spherical mirror 220 captured by at least the two cameras. Specifically, any subject in any position in the space shown in FIG. 16 may be simultaneously subjected to stereo imaging and a distance may be appropriately estimated.

Furthermore, four or more cameras may be used.

In the foregoing description, the case where the image processing apparatus 200 generates a depth map is described as an example. However, a security camera employing the image processing apparatus 200, for example, may be configured. This is because, as described above, since a whole-sky image may be obtained using the image processing apparatus 200, images may be easily obtained in locations where it is difficult to install cameras.

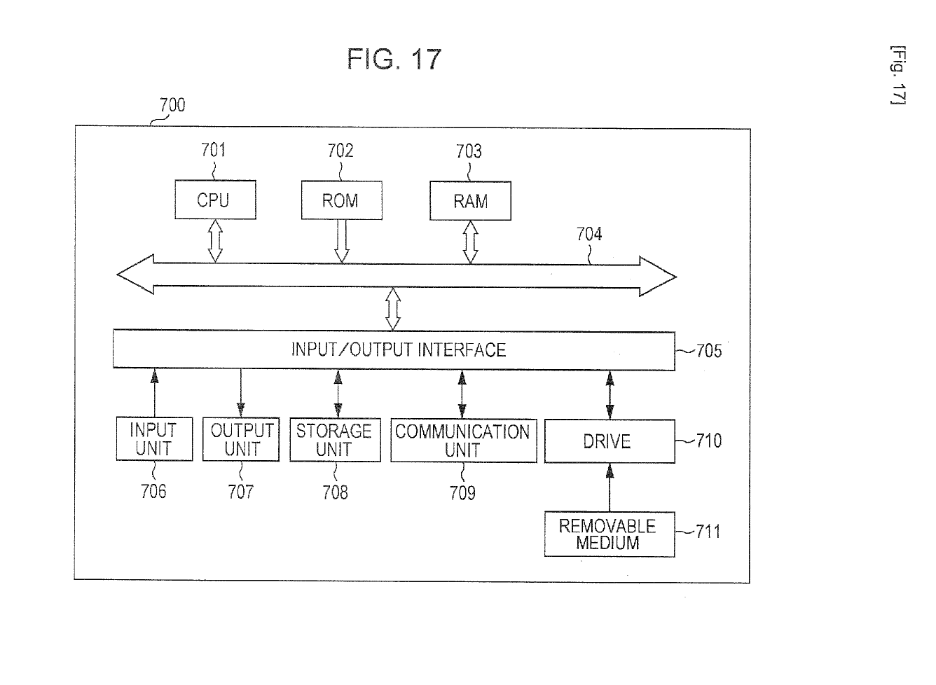

Note that the series of processes described above may be executed by hardware or software. When the series of processes described above is to be executed by software, programs included in the software are installed in a computer which is incorporated in dedicated hardware or a general personal computer 700 shown in FIG. 17, for example, capable of executing various functions by installing various programs through a network or a recording medium.

In FIG. 17, a CPU (Central Processing Unit) 701 performs various processes in accordance with programs stored in a ROM (Read Only Memory) 702 or programs loaded from a storage unit 708 to a RAM (Random Access Memory) 703. The ROM 703 also appropriately stores data used when the CPU 701 executes various processes.

The CPU 701, the ROM 702, and the RAM 703 are connected to one another through a bus 704. An input/output interface 705 is also connected to the bus 704.

To the input/output interface 705, an input unit 706 including a keyboard and a mouse, a display including an LCD (Liquid Crystal display), an output unit 707 including a speaker, the storage unit 708 including a hard disk, and a communication unit 709 including a modem and a network interface card such as a LAN card are connected. The communication unit 709 performs a communication process through a network including the Internet.

A drive 710 is also connected to the input/output interface 705 where appropriate to which a removable medium 711 such as a magnetic disk, an optical disc, a magneto-optical disc, or a semiconductor memory is appropriately attached. A computer program read from the removable medium 711 is installed in the storage unit 708 where appropriate.

When the series of processes described above is to be executed by software, programs included in the software are installed from a network such as the Internet or a recording medium such as the removable medium 711.

Note that the recording medium includes not only the removable medium 711 such as a magnetic disk (including a floppy disk (registered trademark)), an optical disc (including CD-ROM (Compact Disk-Read Only Memory), and a DVD (Digital Versatile Disk)), an magneto-optical disc (including MD (Mini-Disk) (registered trademark)), or a semiconductor memory which is distributed to a user so as to distribute programs and which is provided separately from an apparatus body but also the ROM 702 which stores the programs and the hard disk included in the storage unit 708 which are distributed to the user while being incorporated in the apparatus body in advance.

Note that the series of processes described above in this specification includes, in addition to processes performed in the described order in a time series manner, processes executed in parallel and processes individually executed.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Although illustrative embodiments of the invention have been described in detail herein with reference to the accompanying drawings, the embodiment of the present invention is not limited to the embodiment described above, and various modifications may be made without departing from the scope of the present invention.

It should be noted that the present disclosure can also take the following configurations.

(1) An image processing apparatus comprising:

an image pickup unit configured to capture images of a spherical mirror using a plurality of cameras from different directions; and

a distance estimation unit configured to estimate a distance to an object in the spherical mirror in accordance with values of pixels corresponding to images of the spherical mirror captured by the cameras.

(2) The image processing apparatus according to (1), further comprising:

a mapping unit configured to generate a mapping image by mapping the pixels of the images of the spherical mirror captured by the cameras in a cylinder screen having a predetermined radius and having an axis which passes a center of the spherical mirror,

wherein the distance estimation unit estimates the distance to the object in the spherical mirror in accordance with pixels of the mapped image.

(3) The image processing apparatus according to (2),

wherein the mapping unit specifies a vector of a light beam which is incident on or reflected by a point on a surface of the spherical mirror by specifying a coordinate of the point on the surface of the spherical mirror and a coordinate of a center of a lens of the camera in a three-dimensional space including the center of the spherical mirror as an origin, and

the mapping unit maps a pixel corresponding to the point on the surface of the spherical mirror in the cylinder screen in accordance with the specified vector.

(4) The image processing apparatus according to (3),

wherein the mapping unit generates a plurality of the mapping images by setting different values as values of radii of the cylinder screen for the images of the spherical mirror captured by the cameras,

the distance estimation means calculates difference absolute values of values of pixels corresponding to the mapping images mapped in the cylinder screen, and the distance estimation means estimates a distance to the object in the spherical mirror by specifying one of the values of the radii of the mapping images which corresponds to the minimum difference absolute value among the calculated difference absolute values.

(5) The image processing apparatus according to (1),

wherein images of the spherical mirror are captured by three cameras installed in vertices of a regular triangle having a point corresponding to the center of the spherical mirror as a center of gravity.

(6) The image processing apparatus according to (1), further comprising:

depth map generation means for generating a depth map by storing estimated distances of pixels included in the mapping images after the distances are associated with positions of the pixels.

(7) An image processing method comprising:

capturing images of a spherical mirror using a plurality of cameras from different directions using an image pickup unit; and

estimating a distance to an object in the spherical mirror in accordance with values of pixels corresponding to images of the spherical mirror captured by the cameras using a distance estimation unit.

(8) A program which causes a computer to function as an image processing apparatus comprising:

an image pickup unit configured to capture images of a spherical mirror using a plurality of cameras from different directions; and

a distance estimation unit configured to estimate a distance to an object in the spherical mirror in accordance with values of pixels corresponding to the images of the spherical mirror captured by the cameras.

1. An apparatus for generating an image, comprising:
a plurality of image capturing devices that capture images including objects reflected by a curved mirror from predetermined angles;
an analyzing unit that analyzes image units included in a captured image; and
a distance estimating unit that determines a distance for an object included in the captured images according to an analyzing result of the analyzing unit.

2. The apparatus according to claim 1, further comprising a depth image generating unit that generates a depth image according to the captured images.

3. The apparatus according to claim 1, wherein the plurality of image capturing devices include two image capturing devices disposed at equal distances from the curved mirror.

4. The apparatus according to claim 1, further comprising:
a mapping unit that maps the image units of captured images with virtual units on a plurality of predetermined curved virtual surfaces centered on the curved mirror and associates the virtual units and the image units of the captured images.

5. The apparatus according to claim 4, wherein the curved mirror has a spherical shape, and the curved virtual surface has a cylindrical shape.

6. The apparatus according to claim 5, wherein the mapping unit determines a three-dimensional vector of a light beam reflected by a point of the curved mirror by using a coordinate of the point of the curved mirror and a coordinate of an image capturing device,
wherein the coordinates specify a three-dimensional space that has the center of the curved mirror as an origin, and the coordinate of the image capturing device represents a center of a lens of the image capturing device, and
wherein the mapping unit generates a mapped image by mapping an image unit corresponding to the point of the curved mirror with a virtual unit on a virtual curved surface according to the three-dimensional vector.

7. The apparatus according to claim 6, wherein the distance estimating unit determines the distance for an object included in an image unit based on a minimum value of a location difference of the mapped virtual units associated with the image unit.

8. The apparatus according to claim 6, wherein the image unit includes a pixel or a region formed of a plurality of pixels.

9. The apparatus according to claim 7, wherein the mapping unit generates a plurality of mapped images by mapping a captured image to the plurality of the virtual curved surfaces having a series of radii, the distance estimating unit calculates absolute values of virtual units on the virtual curved surfaces, and the distance estimating unit estimates a distance to an object by using one radius that corresponds to the minimum difference absolute value among the calculated absolute values.

10. A method for generating an image by an apparatus, comprising the steps of:
capturing images including objects reflected by a curved mirror from predetermined angles;
analyzing image units included in a captured image; and
estimating a distance for the object according to an analyzing result of the analyzing unit.

11. The method to claim 10, further comprising the step of generating a depth image according to the captured images.

12. The method according to claim 10, further comprising the step of generating a mapped image by mapping the image units of captured images with virtual units on a plurality of predetermined curved virtual surfaces centered on the curved mirror and associating the virtual units and the image units of the captured images.

13. The method according to claim 12, wherein the curved mirror has a spherical shape, and the curved virtual surface has a cylindrical shape,
wherein the mapping step determines a three-dimensional vector of a light beam reflected by a point of the curved mirror by using a coordinate of the point of the curved mirror and a coordinate of an image capturing device,
wherein the coordinates specify a three-dimensional space that has the center of the curved mirror as an origin, and the coordinate of the image capturing device represents a center of a lens of an image capturing device, and
wherein the mapping step generates a mapped image by mapping an image unit corresponding to the point of the curved mirror with a virtual unit on a virtual curved surface according to the three-dimensional vector.

14. The method according to claim 13, wherein the estimating step determines the distance for an object included in an image unit based on a minimum value of a location difference of the mapped virtual units associated with the image unit.

15. The method according to claim 14, wherein the image unit includes a pixel or a region formed of a plurality of pixels,
wherein the mapping step generates a plurality of mapped images by mapping a captured image to the plurality of the virtual curved surfaces having a series of radii, the estimating step calculates absolute values of virtual units on the virtual curved surfaces, and the estimating step estimates a distance to the object by using one radius that corresponds to the minimum difference absolute value among the calculated absolute values.

16. A non-transitory recording medium storing a program that instructs a computer connected with image capturing devices to generate an image by performing the steps of:
capturing images including objects reflected by a curved mirror from predetermined angles by a plurality of image capturing devices;
analyzing image units included in a captured image; and
estimating a distance for the object according to an analyzing result of the analyzing unit.

17. The A non-transitory recording medium to claim 16, further comprising the step of generating a depth image according to the captured images, and
the step of generating mapped images by mapping the image units of captured images with virtual units on a plurality of predetermined curved virtual surfaces centered on the curved mirror and associating the virtual units and the image units of the captured images.

18. The A non-transitory recording medium according to claim 17, wherein the curved mirror has a spherical shape, and the curved virtual surface has a cylindrical shape,
wherein the mapping step determines a three-dimensional vector of a light beam reflected by a point of the curved mirror by using a coordinate of the point of the curved mirror and a coordinate of an image capturing device,
wherein the coordinates specify a three-dimensional space that has the center of the curved mirror as an origin, and the coordinate of the image capturing device represents a center of a lens of an image capturing device, and
wherein the mapping step generates a mapped image by mapping an image unit corresponding to the point of the curved mirror with a virtual unit on a virtual curved surface according to the three-dimensional vector.

19. The A non-transitory recording medium according to claim 18, wherein the estimating step determines the distance for an object included in an image unit based on a minimum value of a location difference of the mapped virtual units associated with the image unit.

20. The method according to claim 19, wherein the image unit includes a pixel or a region formed of a plurality of pixels,
wherein the mapping step generates a plurality of mapped images by mapping a captured image to the plurality of the virtual curved surfaces having a series of radii, the estimating step calculates absolute values of virtual units on the virtual curved surfaces, and the estimating step estimates a distance to the object by using one radius that corresponds to the minimum difference absolute value among the calculated absolute values.
